(19) United States
(12) Patent Application Publication
(10) Pub. No.: US 2024/0404221 A1
(43) Pub. Date: Dec. 5, 2024

(54) METHOD AND DEVICE FOR DISPLAYING INFORMATION USING AUGMENTED REALITY IMAGE

(71) Applicant: SAMSUNG ELECTRONICS CO., LTD., Suwon-si (KR)

(72) Inventors: Byeongwook YOO, Suwon-si (KR); Seyoung LEE, Suwon-si (KR); Insun HAN, Suwon-si (KR)

(73) Assignee: SAMSUNG ELECTRONICS CO., LTD., Suwon-si (KR)

(21) Appl. No.: 18/806,088

(22) Filed: Aug. 15, 2024

Related U.S. Application Data
(63) Continuation of application No. PCT/KR2024/007499, filed on May 31, 2024.

(30) Foreign Application Priority Data
Jun. 1, 2023 (KR) 10-2023-0071181
Aug. 30, 2023 (KR) 10-2023-0114261

(51) Int. Cl. G06T 19/00; G06F 3/01

(52) U.S. Cl. CPC G06T 19/006; G06F 3/013

(57) ABSTRACT

A method is performed by an augmented reality (AR) device. The method includes identifying a device of interest; determining whether to display information about the device of interest and displaying an AR image corresponding to the information about the device of interest.

### CROSS-REFERENCE TO RELATED APPLICATIONS

This application is a by-pass continuation application of International Application No. PCT/KR2024/007499, filed on May 31, 2024, which is based on and claims priority to Korean patent applications Nos. 10-2023-0071181, filed on Jun. 1, 2023, and 10-2023-0114261, filed on Aug. 30, 2023, in the Korean Intellectual Property Office, the disclosures of which are incorporated by reference herein their entireties.

### BACKGROUND

### 1. Field

The disclosure relates to an augmented reality (AR) device and a method of operating the same, and a method and device for providing, to a user, information related to another device by displaying information as an AR image.

### 2. Description of Related Art

In augmented reality (AR) technology, virtual objects or information is synthesized with a real world environment so that the virtual objects or information looks like objects in a real world physical environment. Modern computing and display technologies have enabled the development of systems for AR experiences. In the AR experiences, a digitally-regenerated image or a part thereof may be presented to users in such a way as to be perceived as being real.

Through the AR technology, virtual images may be overlaid and displayed together on a physical environmental space of the real world or on a real world object. As interest in AR technology increases, various technologies for implementing AR has been developed. AR devices (e.g., smart glasses) that utilize AR technology are useful for, for example, information searching, direction finding, and camera photography.

AR devices are capable of acquiring data from the user's perspective. In particular, smart glasses may display, through a transparent display, a virtual image overlaid on an image of a physical environment of the real world.

In an AR environment where objects in a real world space and virtual objects coexist, various types of information about the real world environment may be provided to users through AR images.

### SUMMARY

According to an aspect of the disclosure, a method, performed by an augmented reality (AR) device, may include: identifying a device of interest; determining whether to display information about the device of interest; and displaying an AR image corresponding to the information about the device of interest.

The determining whether to display the information about the device of interest may include: receiving device identification information and notification information from the device of interest; identifying whether the device of interest may include a display screen based on the device identification information; and based on identifying that the device of interest does not include the display screen, determining to display the notification information.

The determining whether to display the information about the device of interest may include, based on identifying that the device of interest may include the display screen, determining whether to display the information about the device of interest based on a facing direction of the display screen.

The determining whether to display the information about the device of interest based on the facing direction of the display screen may include, based on a difference between the facing direction of the display screen and a direction of the AR device from the device of interest being greater than a preset threshold angle, determining to display the information about the device of interest.

The determining whether to display the information about the device of interest may include: based on identifying that the device of interest may include the display screen, measuring a distance between the AR device and the device of interest; and determining whether to display the information about the device of interest based on the distance between the AR device and the device of interest.

The determining whether to display the information about the device of interest based on the distance between the AR device and the device of interest may include, based on the distance between the AR device and the device of interest being greater than a preset threshold value, determining to display the information about the device of interest.

The device of interest may include at least one of: a device in which an event occurred among devices connected to the AR device, a device selected by a user from among the devices connected to the AR device, or a device newly connected to the AR device.

The identifying the device of interest may include: identifying, through an eye tracking sensor, a device at which a user is gazing; identifying whether the device at which the user is gazing is connected to the AR device; and based on identifying that the device at which the user is gazing is connected to the AR device, determining the device at which the user is gazing as the device of interest.

The identifying, through the eye tracking sensor, the device at which the user is gazing may include: acquiring, through the eye tracking sensor, a gaze direction of the user; acquiring, through a camera, a real world scene image; identifying at least one device from the real world scene image; and determining the device at which the user is gazing based on a location of the at least one device in the real world scene image and the gaze direction of the user.

The displaying the AR image corresponding to the information about the device of interest may include: acquiring, through a camera, a real world scene image; identifying the device of interest from the real world scene image; determining an area to display the AR image based on a location of the device of interest; and displaying the AR image on the determined area.

According to an aspect of the disclosure, an augmented reality (AR) device configured to display information about a device connected to the AR device, includes: a display; a memory storing a program including one or more instructions; and at least one processor configured to execute the one or more instructions, wherein the one or more instructions, when executed by the at least one processor, cause the AR device to: identify a device of interest, determine whether to display information about the device of interest, and display an AR image corresponding to the information about the device of interest through the display.

The one or more instructions, when executed by the at least one processor, may further cause the AR device to: receive device identification information and notification information from the device of interest, identify whether the device of interest may include a display screen based on the device identification information, and based on identifying that the device of interest does not include the display screen, determine to display the notification information.

The one or more instructions, when executed by the at least one processor, may further cause the AR device to, based on identifying that the device of interest may include the display screen, determine whether to display the information about the device of interest based on a facing direction of the display screen.

The one or more instructions, when executed by the at least one processor, may further cause the AR device to, based on a difference between the facing direction of the display screen and a direction of the AR device from the device of interest being greater than a preset threshold angle, determine to display the information about the device of interest.

The one or more instructions, when executed by the at least one processor, may further cause the AR device to: based on identifying that the device of interest may include the display screen, measure a distance between the AR device and the device of interest; and determine whether to display the information about the device of interest based on the distance between the AR device and the device of interest.

The one or more instructions, when executed by the at least one processor, may further cause the AR device to, based on the distance between the AR device and the device of interest being greater than a preset threshold value, determine to display the information about the device of interest.

The one or more instructions, when executed by the at least one processor, may further cause the AR device to: identify, through an eye tracking sensor, a device at which a user is gazing, identify whether the device at which the user is gazing is connected to the AR device, and based on identifying that the device at which the user is gazing is connected to the AR device, determine the device at which the user is gazing as the device of interest.

The AR device may further include a camera, and the one or more instructions, when executed by the at least one processor, may further cause the AR device to: acquire, through the eye tracking sensor, a gaze direction of the user, acquire, through the camera, a real world scene image, identify at least one device from the real world scene image, and determine the device at which the user is gazing based on a location of the at least one device in the real world scene image and the gaze direction of the user.

The AR device may further including a camera, and the one or more instructions, when executed by the at least one processor, may further cause the AR device to: acquire, through the camera, a real world scene image; identify the device of interest from the real world scene image; determine an area to display the AR image based on a location of the device of interest; and display the AR image on the determined area.

According to an aspect of the disclosure, a computer-readable recording medium has recorded thereon a program that is executed by at least one at least one processor to perform the method.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an operation in which an augmented reality (AR) device displays information of a device of interest, according to an embodiment of the disclosure;

FIG. 2 is a flowchart of a method, performed by an AR device, of displaying information, according to an embodiment of the disclosure;

FIG. 3 is a diagram illustrating operations in which an AR device displays an AR image including information about a device of interest, according to an embodiment of the disclosure;

FIG. 4 is a diagram illustrating an operation of identifying a device of interest according to a selection of a user, according to an embodiment of the disclosure;

FIG. 5 is a diagram illustrating an operation in which an AR device identifies devices of interest and displays an AR image including information about the devices of interest, according to an embodiment of the disclosure;

FIG. 6 is a diagram illustrating an operation in which an AR device displays an AR image including information about a plurality of devices of interest, according to an embodiment of the disclosure;

FIG. 7A is a diagram illustrating an example in which an AR device displays an AR image including information about a device of interest, according to an embodiment of the disclosure;

FIG. 7B is a diagram illustrating an example in which an AR device displays an AR image including information about a device of interest, according to an embodiment of the disclosure;

FIG. 7C is a diagram illustrating an example in which an AR device displays an AR image including information about a device of interest, according to an embodiment of the disclosure;

FIG. 7D is a diagram illustrating an example in which an AR device displays an AR image including information about a device of interest, according to an embodiment of the disclosure;

FIG. 8 is a block diagram of an AR device according to an embodiment of the disclosure; and

FIG. 9 is a diagram illustrating an AR device in the form of glasses, according to an embodiment of the disclosure.

### DETAILED DESCRIPTION

Hereinafter, embodiments of the disclosure will be described in detail with reference to the accompanying drawings so that those of ordinary skill in the art may easily implement the embodiments of the disclosure. However, the disclosure may be embodied in many different forms and should not be construed as being limited to the embodiments set forth herein. Also, portions irrelevant to the description of the disclosure will be omitted in the drawings for a clear description of the disclosure, and like reference numerals will denote like elements throughout the specification.

The terms used herein are those general terms currently widely used in the art in consideration of functions in the disclosure, but the terms may vary according to the intentions of those of ordinary skill in the art, precedents, or new technology in the art. Also, in some cases, there may be terms that are optionally selected by the applicant, and the meanings thereof will be described in detail in the corresponding portions of the disclosure. Thus, the terms used herein should be understood not as simple names but based on the meanings of the terms and the overall description of the disclosure.

As used herein, the singular forms “a,” “an,” and “the” may include the plural forms as well, unless the context clearly indicates otherwise. Unless otherwise defined, all terms (including technical or scientific terms) used herein may have the same meanings as commonly understood by those of ordinary skill in the art of the disclosure.

Throughout the disclosure, when something is referred to as “including” an element, one or more other elements may be further included unless specified otherwise. Also, as used herein, terms such as “units” and “modules” may refer to units that perform at least one function or operation, and the units may be implemented as hardware or software or a combination of hardware and software.

Throughout the specification, when an element is referred to as being “connected” to another element, it may be “directly connected” to the other element or may be “electrically connected” to the other element with one or more intervening elements therebetween. In addition, the terms “comprises” and/or “comprising” or “includes” and/or “including” when used in this specification, specify the presence of stated elements, but do not preclude the presence or addition of one or more other elements.

The expression “configured to (or set to)” used herein may be used interchangeably with, for example, “suitable for”, “having the capacity to”, “designed to”, “adapted to”, “made to”, or “capable of”, according to situations. The expression “configured to (or set to)” may not only necessarily refer to “specifically designed to” in terms of hardware. Instead, in some situations, the expression “system configured to” may mean that the system is “capable of” along with other devices or components. For example, “a processor configured to (or set to) perform A, B, and C” may refer to a dedicated processor (e.g., an embedded processor) for performing a corresponding operation, or a general-purpose processor (e.g., a central processing unit (CPU) or an application processor) capable of performing a corresponding operation by executing one or more software programs stored in a memory.

The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

A function related to “artificial intelligence (AI)” according to the disclosure may be performed by a processor and a memory. The processor may include one processor or a plurality of processors. In this regard, one processor or the plurality of processors may include a general-purpose processor, such as a CPU, an application processor (AP), a digital signal processor (DSP), etc., a graphic-dedicated processor, such as a GPU, a vision processing unit (VPU), etc., or an AI-dedicated processor, such as a neural processing unit (NPU). One processor or the plurality of processors may process data according to a predefined operation rule or AI model stored in the memory. When one processor or the plurality of processors include an AI-dedicated processor, the AI-dedicated processor may be designed to have a hardware structure specialized for processing a specific AI model.

The predefined operation rule or AI model may be made through training. Herein, when the AI model is made through training, it may mean that a basic AI model (or a deep learning model) is trained based on a learning algorithm by using multiple training datasets, such that the predefined operation rule or AI model set to execute desired characteristics (or purpose) is made. Such training may be performed by a device on which AI according to the disclosure is implemented, or by a separate server and/or system. Examples of a learning algorithm may include, but not limited to, supervised learning, unsupervised learning, semi-supervised learning, or reinforcement learning.

The artificial intelligence model (or the deep learning model) may include a plurality of neural network layers. Each of the plurality of neural network layers may have a plurality of weight values, and perform a neural network operation through an operation between an operation result of a previous layer and the plurality of weight values. The plurality of weight values of the plurality of neural network layers may be optimized by a training result of the AI model. For example, the plurality of weight values may be updated to reduce or minimize a loss value or a cost value acquired in the AI model during a training process. Examples of the AI neural network may include, but not limited to, a deep neural network (DNN), a convolutional neural network (CNN), a recurrent neural network (RNN), a restricted Boltzmann machine (RBM), a deep belief network (DBN), a bidirectional recurrent deep neural network (BRDNN), and a deep Q-network.

In the disclosure, “AR” shows virtual images together in a physical environment space of the real world or shows real world objects and virtual images together.

In the disclosure, an “AR device” is a device capable of expressing AR, and may display images including physical objects that exist in reality and virtual objects. The AR device may include, for example, not only AR glasses in the shape of glasses worn on the face of a user but also a head mounted display (HMD) or an AR helmet worn on the head.

Hereinafter, the disclosure will be described in detail with reference to the accompanying drawings.

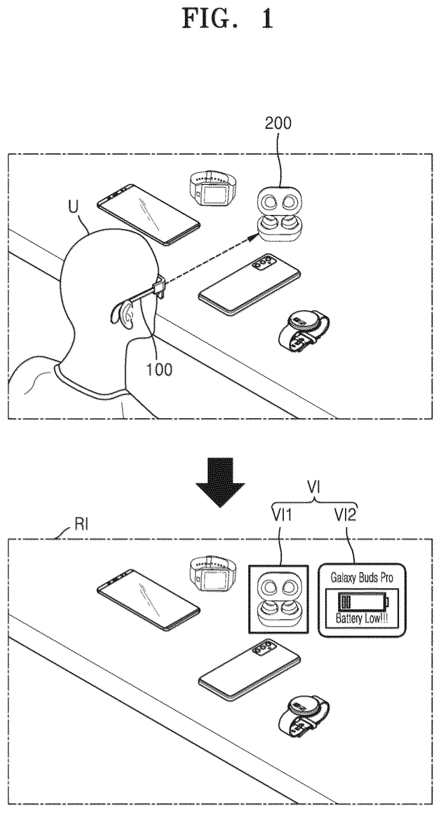

FIG. 1 is a diagram illustrating an operation in which an AR device 100 displays information of a device of interest 200, according to an embodiment of the disclosure.

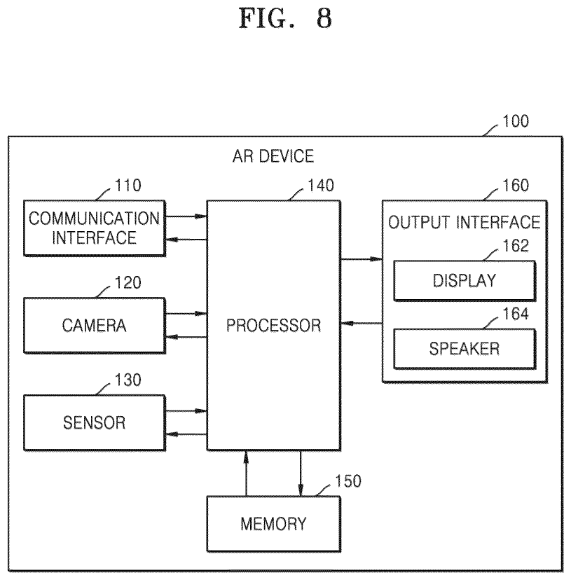

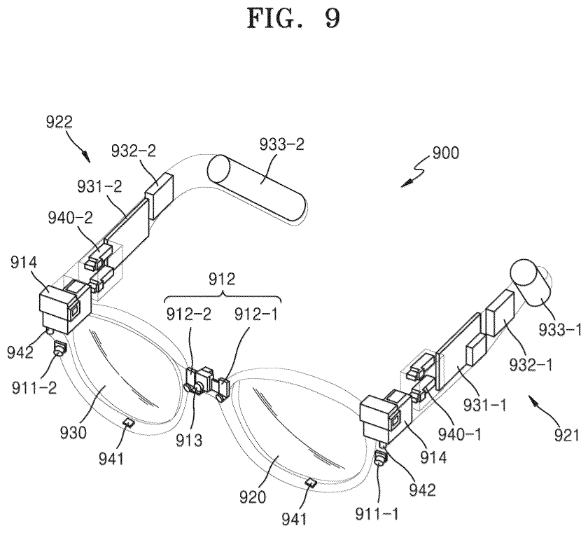

The AR device 100 can display (or express) AR, and may include, for example, AR glasses worn on the face of a user U. Components of the AR device 100 will be described in more detail with reference to FIGS. 8 and 9 below.

In an embodiment, the AR device 100 may identify the device of interest 200. The device of interest 200 may be a target object for providing information through the AR device 100. The information related to the device of interest 200 may be displayed as an AR image VI through the AR device 100.

Among devices connected to the AR device 100, a device requiring notification may be the device of interest 200. For example, the device of interest 200 may include at least one of a device in which an event occurred among the devices connected to the AR device 100, a device selected by the user U among the devices connected to the AR device 100, or a device newly connected to the AR device 100.

The at least one device (e.g., an electronic device) may be connected to or paired with the AR device 100 through short-distance wireless communication. When an event requiring notification to the user U occurs in a specific device connected to the AR device 100, the notification may be displayed on a display of the specific device by itself. In an embodiment, the at least one device may not include a display for displaying the notification by itself. In this case, instead, the AR device 100 may be used to provide notifications related to the at least one device to the user U.

In an embodiment, when a device that was not connected to the AR device 100 is newly connected to the AR device 100, the newly connected device may be the device of interest 200 that requires the notification through the AR device 100. When the device that was not connected to the AR device 100 is newly paired to the AR device 100, it may be necessary to notify the user U of the AR device 100 of a pairing between the AR device 100 and the device that was not connected to the AR device 100. In this case, the AR device 100 may display the AR image VI to inform the user U of the pairing between the AR device 100 and the device that was not connected to the AR device 100.

In an embodiment, the device of interest 200 may be selected by the user U among the devices connected to the AR device 100. The user U may select, as the device of interest 200, a device about which the user U wants to know related information. The user U may select the device of interest 200 through a speech signal or by gazing at a specific device. The information about the device of interest 200 selected by the user U may be provided to the user U in the form of a notification through the AR image VI.

In an embodiment, the AR device 100 may identify a device at which the user U gazes through an eye tracking sensor. For example, the AR device 100 may acquire a gaze direction of the user U through the eye tracking sensor. In an embodiment, the gaze direction of the user U may be expressed as position coordinates of an area at which the user U gazes in a real world environment, or as a vector from the AR device 100 to a position at which the user U gazes. In an embodiment, the gaze direction of the user U may be acquired through eye fixation analysis. In the eye fixation analysis, when the gaze of the user U stays in an area of a certain range for more than a preset time, a device located in the area may be determined as the device at which the user U gazes. For example, the preset time may be approximately 150 ms to 300 ms. In an embodiment, a range in which the gaze direction shakes when the user U gazes at a specific device or a time taken for the user U to gaze at the specific device may vary depending on the user U of the AR device 100. Accordingly, the range or preset time for eye fixation analysis may vary depending on the user U of the AR device 100.

In addition, as shown in FIG. 1, the AR device 100 may acquire a real world scene image RI through a camera. For example, the camera may be a depth camera or an RGB camera. For example, the real world scene image RI acquired through the depth camera or the RGB camera may be respectively a depth image or an RGB image. Thereafter, the AR device 100 may segment (divide) the acquired real world scene image RI. A segmentation operation may represent or correspond to an operation of extracting an object in pixel units from an image. The segmentation operation may be used to recognize or separate an object in an images or a video. For example, through the segmentation operation, each pixel may be assigned a label for the purpose of determining a location of an object in an image, a shape, and determining which pixel belongs to which object.

In an embodiment, the AR device 100 may segment the real world scene image RI according to (or based on) a shape, location, type, etc. of an object. For example, the AR device 100 may segment the real world scene image RI using panoptic segmentation technology to acquire object-specific identification information. Each segmented image piece may represent one object. That is, object recognition may be achieved from the real world scene image RI through the segmentation operation. Object recognition or object identification may refer to an operation of identifying an object included in an image or video. For example, object recognition may include analyzing visual information in an image to classify what type of object it is. An object may include any object that is distinct from the background in an image. According to an embodiment, a process of determining whether an object exists in an image and a location of the object may also be included in object recognition. Object recognition is a kind of pattern recognition, and for example, may identify an object included in an image or video using a trained neural network model.

An image piece corresponding to one object may be expressed as an ‘object image’. The AR device 100 may identify at least one device image from the segmented real world scene image RI. For example, the AR device 100 may store identification information about at least one connected device, for example, information such as a type of each connected device, shape, or color. The AR device 100 may match at least one object image with the connected device, based on the stored device identification information and the acquired real world scene image RI. The object image matching the device may be identified as a device image.

In an embodiment, the segmented real world scene image RI may include an object image for which the AR device 100 may not determine which device corresponds to the object image. For example, the real world scene image RI (acquired by the AR device 100) may include two or more devices of the same type. In this case, it may be difficult for the AR device 100 to identify which object image corresponds to which device among two or more devices. For example, when the real world scene image RI acquired by the AR device 100 includes two object images for ‘wireless earphones,’ it may be difficult for the AR device 100 to identify which of the two object images corresponds to the wireless earphones connected to the AR device 100.

In an embodiment, the AR device 100 may use another sensor or a signal exchange method to match an object image and a device. The AR device 100 may match the object image and the device using a Global Positioning System (GPS), Bluetooth Low Energy (BLE), or Ultra Wide Broadband (UWB) method. For example, the GPS method may be effective when the device and the AR device 100 are far away, and the BLE method or the UWB method may be effective when the device and the AR device 100 are close, for example, when a distance therebetween is 100 m or less. In an embodiment, the AR device 100 may exchange signals with the connected device to match the device and the object image. For example, the AR device 100 may request to output sound from the connected device (e.g., wireless earphones), and the device that receives a request may output the sound. Sound may have various frequencies, and is not limited to an area that the AR device 100 or the user U of the device may hear. The AR device 100 may receive the sound output from the device and determine a feature (such as a direction, a location, a distance) of the device, and identify an object image matching the device by using information such as the determined feature (such as the direction, the location, and the distance) of the device. In an embodiment, the AR device 100 may perform the BLE method or the UWB method compared to the signal exchange method so as to match the object image and the device.

The AR device 100 may determine a device at which the user U gazes based on location information within the real world scene image RI of at least one device image and gaze direction information of the user U. For example, the AR device 100 may determine a device corresponding to an object image located in the gaze direction of the user U as the device at which the user U gazes.

The AR device 100 may identify whether the device at which the user U gazes is connected to the AR device 100, and, when the device at which the user U gazes is connected to the AR device 100, may determine the device at which the user U gazes as the device of interest 200.

In an embodiment, the AR device 100 may determine whether to display the information about the device of interest 200. For example, when the user U can acquire the information about the device of interest 200, because the AR device 100 does not need to display the information redundantly, the AR device 100 may determine not to display the information. When the user U cannot acquire the information about the device of interest 200, the AR device 100 may display the information through the AR image VI and provide the information to the user U.

In an embodiment, an operation of determining whether the AR device 100 displays the information about the device of interest 200 may include determining to display the information about the device of interest 200 when the device of interest 200 does not include a display screen. When the device of interest 200 does not include its own display screen, the user U may not see the information about the device of interest 200. Therefore, in this case, the AR device 100 may receive the information about the device of interest 200 from the device of interest 200 and display the information as the AR image VI such that the user U may see the information.

In an embodiment, whether the device of interest 200 includes the display screen may be included in device identification information received from the device of interest 200. For example, the AR device 100 may receive the device identification information and notification information from the device of interest 200. The device identification information and the notification information may be received in a single operation or in a plurality of separate operations.

In an embodiment, the notification information may be received after the AR device 100 determines to display the information about the device of interest 200. The device identification information is information for identifying the device of interest 200 and may include, for example, at least one of a device type, a device color, or a device identification (ID). The notification information may be related to the device of interest 200 that requires notification to be provided to the user U. For example, the notification information may include information related to events occurring in the device of interest 200, such as the remaining battery level of the device of interest 200, termination of operation of the device of interest 200, or information related to a current state of the device of interest 200.

In an embodiment, the AR device 100 may identify whether the device of interest 200 includes its own display screen based on the device identification information received from the device of interest 200. The AR device 100 may determine to provide the notification information (among the information related to the device of interest 200) to the user U through the AR image VI.

In an embodiment, an operation of determining whether the AR device 100 displays the information about the device of interest 200 may include determining whether to display the information about the device of interest 200 based on a facing direction of a display screen when the device of interest 200 includes the display screen. The facing direction of the display screen indicates a direction in which the display screen faces.

The AR device 100 may detect the display screen of the device of interest 200 based on the device identification information received from the device of interest 200. The AR device 100 may calculate the facing direction of the display screen through a form in which the display screen of the device of interest 200 appears on the real world scene image RI obtained through the camera. For example, a facing angle of the display screen may be calculated through an affine transformation value of an image corresponding to the display screen of the device of interest 200 on the real world scene image RI.

In an embodiment, the AR device 100 may determine to display the information about the device of interest 200 when a difference between the facing direction of the display screen of the device of interest 200 and a direction from the device of interest 200 to the AR device 100 is greater than a preset threshold angle. The direction from the device of interest 200 to the AR device 100 may represent a direction of a straight line connecting the center of the display screen of the device of interest 200 to the camera of the AR device 100. The direction from the camera of the AR device 100 to the center of the display screen of the device of interest 200 may correspond to the gaze direction of the user U wearing the AR device 100. Therefore, when the facing direction of the display screen of the device of interest 200 and the direction from the device of interest 200 to the AR device 100 match, the user U wearing the AR device 100 may best recognize content displayed on the display screen of the device of interest 200, and as the difference between the two directions increases, it may be difficult for the user U to recognize the content displayed on the display screen of the device of interest 200.

In an embodiment of the disclosure, when the difference between the facing direction of the display screen of the device of interest 200 and the direction from the device of interest 200 to the AR device 100 is greater than the preset threshold angle, it may be determined that the user U does not see the content displayed on the display screen of the device of interest 200. When the difference between the facing direction of the display screen of the device of interest 200 and the direction from the device of interest 200 to the AR device 100 is significant, the user U of the AR device 100 may not see the display screen of the device of interest 200, and may not acquire the information even when the device of interest 200 displays related information by itself (e.g., on the display included in the device of interest 200). Therefore, in this case, the AR device 100 may display information that the user U cannot acquire through the AR image VI and provide the information to the user U.

In an embodiment, the operation of determining whether the AR device 100 displays the information about the device of interest 200 may include determining whether to display the information about the device of interest 200 based on a distance between the AR device 100 and the device of interest 200 when the device of interest 200 includes the display screen. The distance between the device of interest 200 and the AR device 100 may represent (or correspond to) a distance of a straight line connecting the center of the display screen of the device of interest 200 to the camera of the AR device 100. The distance between the device of interest 200 and the AR device 100 may be measured through various sensors, such as a stereo camera, a depth sensor, a depth camera, a proximity sensor, a time of flight (ToF) type sensor, etc., or through a signal exchange between the device of interest 200 and the AR device 100. In some embodiments, the distance between the device of interest 200 and the AR device 100 may be measured in various ways that are not limited to the examples described above.

The distance from the camera of the AR device 100 to the center of the display screen of the device of interest 200 may correspond to the gaze distance for the user U wearing the AR device 100 to read the content displayed on the display screen. Accordingly, as the distance between the display screen of the device of interest 200 and the AR device 100 increases, it may be difficult for the user U to recognize the content displayed on the display screen of the device of interest 200.

In an embodiment, when the distance between the device of interest 200 and the AR device 100 is greater than a preset threshold value, it may be determined that the user U may not see the content displayed on the display screen of the device of interest 200. When the distance between the device of interest 200 and the AR device 100 is (relatively) far, the user U of the AR device 100 may not see the display screen of the device of interest 200, and may not acquire the information even when the device of interest 200 displays related information by itself. Therefore, in this case, the AR device 100 may display information that the user U cannot acquire through the AR image VI and provide the information to the user U. In an embodiment, the preset threshold value with respect to the distance between the device of interest 200 and the AR device 100 may be determined based on user information such as vision.

In an embodiment, the AR device 100 may display the AR image VI including the information about the device of interest 200. The AR image VI may include a virtual image VI2 representing information about the device of interest 200. The AR image VI may further include an indicator VI1 indicating the device of interest 200 corresponding to the information.

The AR device 100 may determine an area to display the AR image VI based on a location of the image of the device of interest 200 within the real world scene image RI. Thereafter, the AR device 100 may display the AR image VI in the determined area.

In an embodiment, as shown in FIG. 1, the indicator VI1 indicating the device of interest 200 may be displayed on an edge of the device of interest 200 or may be displayed to overlap with the image of the device of interest 200. The indicator VI1 indicating the device of interest 200 may emphasize the image of the device of interest 200 through various methods and provide location information of the device of interest 200 to the user U.

In an embodiment, the AR device 100 may acquire the real world scene image RI through the camera, segment the acquired real world scene image RI, and identify the image of the device of interest 200. The indicator VI1 indicating the device of interest 200 may be displayed on an area corresponding to the identified image of the device of interest 200.

In an embodiment, as shown in FIG. 1, the virtual image VI2 representing the information about the device of interest 200 may be displayed near the image of the device of interest 200 or may be displayed to overlap with the image of the device of interest 200. In an embodiment, the virtual image VI2 representing the information about the device of interest 200 may not be displayed near the image of the device of interest 200. For example, the virtual image VI2 may be displayed on an area in which there is no other object in the background, or may be displayed by being enlarged in a gaze direction of the user U such that the user U may recognize the information well. When the virtual image VI2 is not displayed near the image of the device of interest 200, the AR image VI may further include a connection line indicating which device of interest 200 the virtual image VI2 corresponds to.

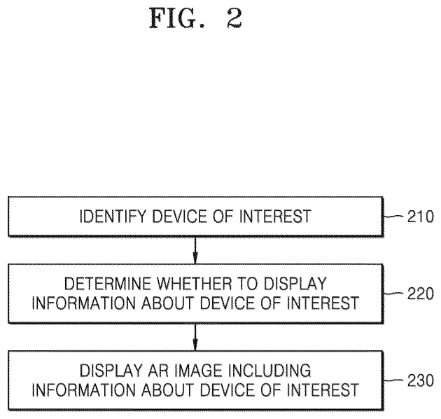

FIG. 2 is a flowchart of a method, performed by an AR device, of displaying information according to an embodiment of the disclosure.

In operation 210, the AR device may identify a device of interest. The device of interest may be a target object for providing information through the AR device.

Among devices connected to the AR device, a device requiring notification may be the device of interest. For example, the device of interest may include at least one of a device in which an event occurred among the devices connected to the AR device, a device selected by the user U among the devices connected to the AR device, or a device newly connected to the AR device.

When an event requiring notification to the user occurs in a specific device connected to the AR device, the specific device may display the notification in a display included in the specific device. In an embodiment, when the specific device does not include the display for displaying the notification by itself, the AR device may be used to provide the notification related to the specific device to the user.

When a device that was not connected to the AR device is newly connected to the AR device, the newly connected device may be the device of interest that requires notification through the AR device. When a device that was not connected to the AR device is newly paired to the AR device, the AR device may display the AR image VI to inform the user of the AR device of a pairing between the AR device and the device that was not connected to the AR device.

In an embodiment, the device of interest may be determined by a selection of the user. For example, when the user selects a specific device that is connected to the AR device, through a speech signal or a gaze signal, the AR device may determine that the user wants to receive a notification or status information of the specific device and provide the notification or status information of the specific device to the user.

In an embodiment, the AR device may identify a device at which the user gazes through an eye tracking sensor. A gaze direction of the user may be determined as a direction when the gaze of the user stays in an area of a certain range for more than a preset time through eye fixation analysis. A device located in the gaze direction of the user may be determined as a device at which the user gazes. For example, the preset time may have a value of approximately 150 ms to 300 ms.

Thereafter, the AR device may identify whether the device at which the user gazes is connected to the AR device. When the device at which the user gazes is connected to the AR device, the AR device may determine the device as the device of interest.

In an embodiment, identifying the device at which the user gazes through the eye tracking sensor may include acquiring the gaze direction of the user through the eye tracking sensor, acquiring a real world scene image through a camera, identifying at least one device from the real world scene image, and determining the device at which the user gazes, based on a location of the at least one device in the real world scene image and the gaze direction of the user.

In operation 220, the AR device may determine whether to display the information about the device of interest. For example, when the user can acquire specific information through other paths, because the AR device does not need to display the specific information redundantly, the AR device may determine not to display the specific information. The information determined by the AR device to be displayed may include information that the user cannot acquire through other paths.

In an embodiment, the AR device may receive device identification information from the device of interest. The device identification information may include information about whether the device of interest includes a display screen. When the device of interest does not include the display screen based on the received device identification information, the AR device may determine to display the information about the device of interest.

In an embodiment, even when the device of interest includes the display screen, and it is determined that the user cannot read the information displayed on the display screen, the AR device may determine to display the information about the device of interest, through an AR image.

For example, when a difference between a facing direction of the display screen of the device of interest and a direction from the device of interest to the AR device is more significant (larger) than a preset threshold angle, the AR device may determine that the user cannot read the display screen and determine to display a notification about the device of interest.

For example, even when a distance to the device of interest measured by the AR device is greater than a preset value, the AR device may determine that the user cannot read the display screen and determine to display the notification about the device of interest. In an embodiment, the preset threshold value with respect to the distance between the device of interest and the AR device may be determined based on user information such as vision.

In operation 230, the AR device may display the AR image including the information about the device of interest. Information related to the device of interest may be displayed as the AR image through the AR device.

In an embodiment, the AR device may identify the device of interest from the real world scene image acquired through the camera and determine an area to display the AR image based on a location of the device of interest. The area to display the AR image may be determined as an area near (or an area next to) the device corresponding to the information, or may be determined as an area moved closer to the gaze direction of the user from the device corresponding to the information. Thereafter, the AR device may display the AR image on the determined area.

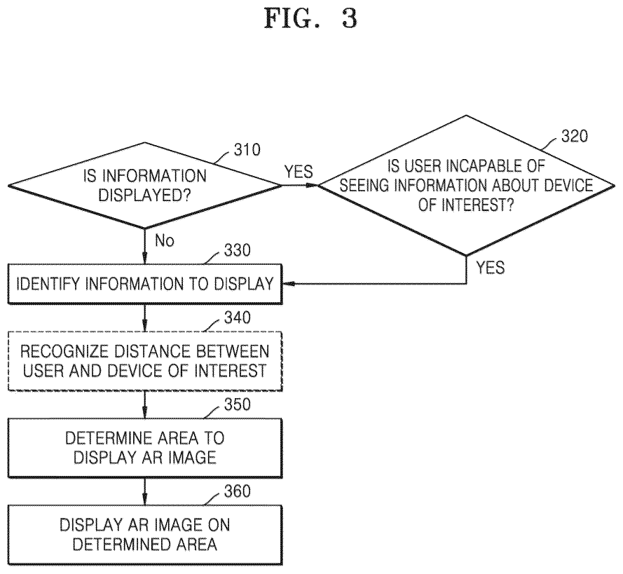

FIG. 3 illustrates operations in which the AR device 100 displays an AR image including information about the device of interest 200, according to an embodiment of the disclosure.

The operations shown in FIG. 3 may be performed after the device of interest 200 is identified. After identifying the device of interest 200, the AR device 100 may determine whether to display the information about the device of interest 200. An operation of determining whether to display the information about the device of interest 200 may be performed through operations 310 and 320.

In operation 310, the AR device 100 may identify whether the information about the device of interest 200 is already displayed. When determining whether to display the information about the device of interest 200, the AR device 100 may consider whether a user can acquire the information. The information about the device of interest 200 may be displayed by the AR device 100 through an AR image, or may be displayed through a display included in the device of interest 200. When the AR device 100 is already displaying the information about the device of interest through the AR image, the AR device 100 may not need to provide the information to the user again. When the device of interest 200 includes the display and already provides a notification by itself, the AR device 100 may not need to redundantly provide the information to the user. Accordingly, when the information about the device of interest 200 is already displayed, the AR device 100 may proceed with operation 320 and determine again whether to display the information.

In an embodiment, when the device of interest 200 does not include a separate display screen and not provide the notification by itself (e.g., through a display included in the device of interest 200), or when the AR device 100 is not currently displaying the information about the device of interest 200, the AR device 100 may proceed with operation 330.

In operation 320, the AR device 100 may identify whether the user cannot see the information about the device of interest 200 even though the information about the device of interest is already displayed.

For example, even when the device of interest 200 includes its own display screen, and when it is determined that the user cannot see the information displayed on the display screen, the AR device 100 may determine to display the information about the device of interest 200 through the AR image. For example, when a difference between a facing direction of the display screen of the device of interest 200 and a direction from the device of interest 200 to the AR device 100 is more significant (or larger) than a preset threshold angle, the AR device 100 may determine that the user cannot see the display screen and determine to display a notification about the device of interest. For example, even when a distance to the device of interest measured by the AR device 100 is greater than a preset value, the AR device 100 may determine that the user cannot see the display screen and determine to display the notification about the device of interest 200. In an embodiment, the preset threshold value with respect to the distance between the device of interest and the AR device 100 may be determined based on user information such as vision.

For example, even when the AR device 100 already displays the information about the device of interest as the AR image, when the information currently displayed is previous information and the user cannot see updated information about the device of interest, the AR device 100 may determine to display the updated information again.

In operation 330, the AR device 100 may identify information to be displayed as the AR image. The AR device 100 may receive information that needs to be provided to the user from the device of interest. For example, the information about the device of interest 200 that needs to be provided to the user may be displayed as notification information. The notification information may be information related to the device of interest 200 that requires the notification to be provided to the user. For example, the notification information may include information related to events occurring in the device of interest 200, such as the remaining battery level of the device of interest 200, termination of operation of the device of interest 200, information related to a current state of the device of interest 200, etc.

In an embodiment, the AR device 100 may select information to display through the AR image from among the information related to the device of interest 200. Selection of the information to display may be based on priority among the information.

In operation 340, the AR device 100 may recognize a distance between the user and the device of interest 200. Operation 340 may be performed optionally. The distance between the user of the AR device 100 and the device of interest 200 measured in operation 340 may be used to determine an area to display the AR image corresponding to the device of interest 200.

In operation 350, the AR device 100 may determine the area to display the AR image. The AR device 100 may determine the area to display the AR image based on a location of the device of interest 200 within a real world scene image.

In an embodiment, the AR device 100 may identify the device of interest 200 from the real world scene image acquired through a camera and determine the area to display the AR image based on the location of the device of interest 200. The area to display the AR image may be determined as an area near (or an area next to) the device corresponding to the information, or may be determined as an area moved closer to a gaze direction of the user from the device corresponding to the information. For example, when the distance between the user of the AR device 100 and the device of interest 200 is far, the area to display the AR image may be determined as the area moved closer to the gaze direction of the user from the device corresponding to the information. Thereafter, in operation 360, the AR device 100 may display the AR image in the area determined in operation 350.

The AR image may include a virtual image representing the information about the device of interest 200. The AR image may further include an indicator indicating the device of interest 200 corresponding to the information.

In an embodiment, the indicator indicating the device of interest 200 may be displayed on an edge of the device of interest 200 or may be displayed to overlap with an image of the device of interest 200. The indicator indicating the device of interest 200 may emphasize the image of the device of interest 200 through various methods, and may provide location information of the device of interest 200 to the user.

In an embodiment, a virtual image representing the information about the device of interest 200 may be displayed near the image of the device of interest 200 or may be displayed to overlap with the image of the device of interest 200. In an embodiment, the virtual image representing the information about the device of interest 200 may not be displayed near the image of the device of interest 200. For example, the virtual image may be displayed on an area in which there is no other object in the background, or may be displayed by being enlarged in a gaze direction of the user such that the user may recognize the information well. When the virtual image is not displayed near the image of the device of interest 200, the AR image may further include a connection line indicating which device of interest the virtual image corresponds to.

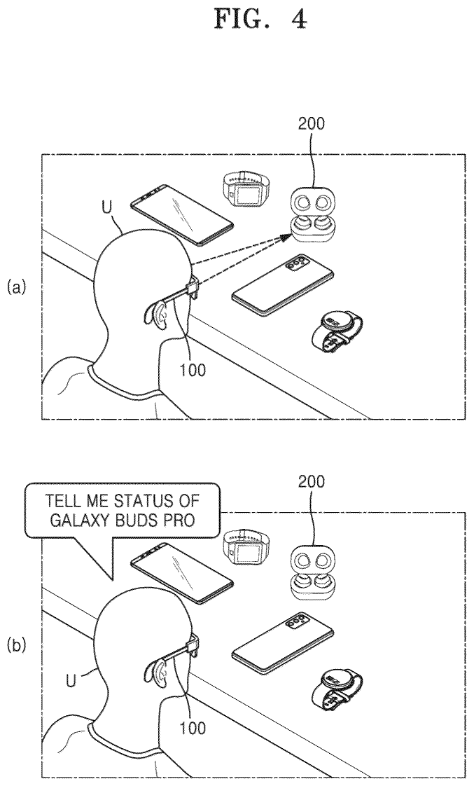

FIG. 4 is a diagram illustrating an operation of identifying the device of interest 200 based on a selection of the user U, according to an embodiment of the disclosure.

In an embodiment, the device of interest 200 may be selected by the user U among the devices connected to the AR device 100. The user U may select a device about which the user U wants to know related information as the device of interest 200. The user U may select the device of interest 200 by gazing at a specific device ((a) of FIG. 4) or may select the device of interest 200 through a speech signal ((b) of FIG. 4). The information about the device of interest 200 selected by the user U may be provided to the user U in the form of a notification through an AR image.

In (a) of FIG. 4, in an embodiment, the AR device 100 may identify a device at which the user U gazes through an eye tracking sensor. For example, the AR device 100 may acquire a gaze direction of the user U through the eye tracking sensor. The gaze direction of the user U may be acquired through eye fixation analysis. In the eye fixation analysis, when the gaze of the user U stays in an area of a certain range for more than a preset time, a device located in the area may be determined as the device at which the user U gazes.

The AR device 100 may determine a device corresponding to an object image located in the gaze direction of the user U as the device at which the user U gazes. When the device at which the user U gazes is connected to the AR device 100, may determine the device at which the user U gazes as the device of interest 200.

In (b) of FIG. 4, the user U may select a specific device as the device of interest 200 through a speech signal.

Speech recognition refers to an operation of converting a speech signal acquired through an input device such as a microphone into a form that may be processed by an electronic device (e.g., the AR device 100). For example, speech recognition may include converting an acoustic speech signal of speech acquired by an AR device into text such as words or sentences, and may be referred to as computer speech recognition or speech-to-text (STT). In an embodiment, the AR device 100 may select a device selected by the user U as the device of interest 200 through speech recognition.

Natural language understanding (NLU) refers to an operation of inputting text or speech in a natural language and processing the text or speech to enable a computer to understand. Through NLU, the AR device 100 may operate according to a user input (“Tell me the status of Galaxy Buds Pro”) given in the natural language.

For example, referring to (b) of FIG. 4, the AR device 100 may determine the device of interest 200 as ‘Galaxy Buds Pro’ through NLU from a natural language speech input of the user U, and determine information to be displayed as status information about ‘Galaxy Buds Pro’, such as remaining battery level and music information being played.

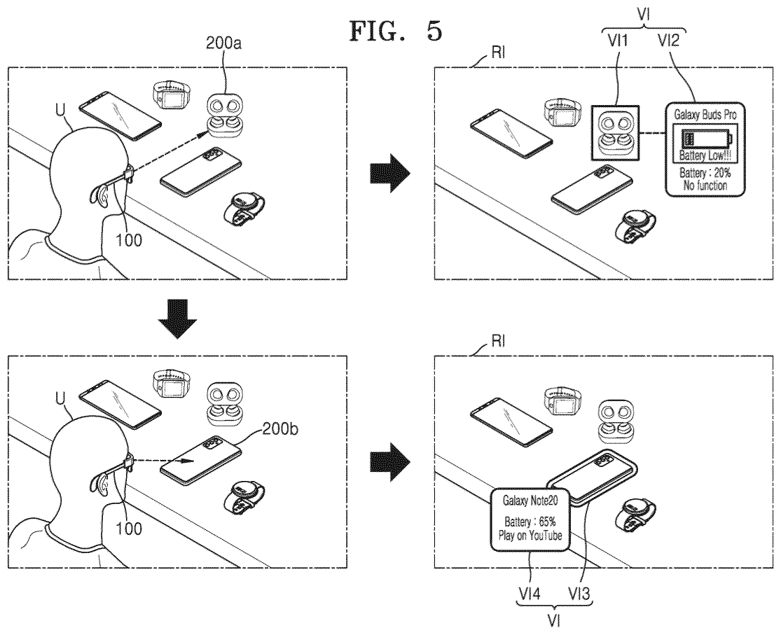

FIG. 5 is a diagram illustrating an operation in which the AR device 100 identifies devices of interest 200a and 200b and displays the AR image VI including information about the devices of interest 200a and 200b, according to an embodiment of the disclosure.

FIG. 5 illustrates an embodiment in which the AR device 100, according to an embodiment of the disclosure, identifies a device at which the user U gazes as the devices of interest through an eye tracking sensor.

First, the user U may gaze the first device 200a (wireless earphones) among devices connected to the AR device 100. In this case, the device of interest is determined as the first device 200a. The first device 200a, which is the ‘wireless earphones,’ does not have its own display and, therefore, may be a target (device of interest) for providing information through the AR device 100.

The AR device 100 may display information about the first device 200a determined as the device of interest through the AR image VI. In an embodiment, the AR image VI may further include the virtual image VI2 representing information about the device of interest (the first device 200a) and the indicator VI1 indicating the device of interest (the first device 200a) corresponding to the information. For example, the indicator VI1 indicating the device of interest (the first device 200a) may be displayed on an edge of the device of interest (the first device 200a) to emphasize the device of interest (the first device 200a). The user U may clearly recognize which information relates to which device through the virtual image VI including the indicator VI1 and the information VI2.

In an embodiment, a connection line connecting these virtual images may be further displayed between the indicator VI1 and the information VI2. When the virtual image representing the information VI2 is displayed near the corresponding device of interest (the first device 200a), it may be clearly understood which device the information relates to, but when the virtual image representing the information VI2 is displayed far from the corresponding device of interest, a notification may be provided more effectively to the user U through the connection line connecting the information VI2 and the indicator VI1 of the device of interest (the first device 200a).

In an embodiment, the user U may gaze at the first device 200a, and then, move the gaze to the second device 200b (a mobile phone). At this time, when the user U gazes the second device 200b for more than a certain period of time, the device of interest may be changed to the second device 200b.

Referring to FIG. 5, the second device 200b has its own display, but a facing direction of the display screen faces the floor, and thus, the user U may not see content displayed on a screen of the second device 200b. In this case, the second device 200b may be a target (device of interest) for providing information through the AR device 100.

The AR device 100 may display information about the second device 200b, which is a changed (new) device of interest, through the AR image VI. In an embodiment, the AR image VI may further include a virtual image VI4 indicating information about the device of interest (the second device 200b) and an indicator VI3 indicating the device of interest (the second device 200b) corresponding to the information. For example, the indicator VI3 indicating the device of interest (the second device 200b) may be displayed on an edge of the device of interest (the second device 200b) to emphasize the device of interest (the second device 200b). The user U may recognize which information relates to which device through the virtual image VI including the indicator VI3 and the information VI4.

In an embodiment, the AR device 100 may display information about only one device of interest at a time. In this case, when the device of interest is changed, the virtual images VI1 and VI2 corresponding to the device of interest before the change may no longer be displayed, and the virtual images VI3 and VI4 corresponding to the new device of interest may be displayed.

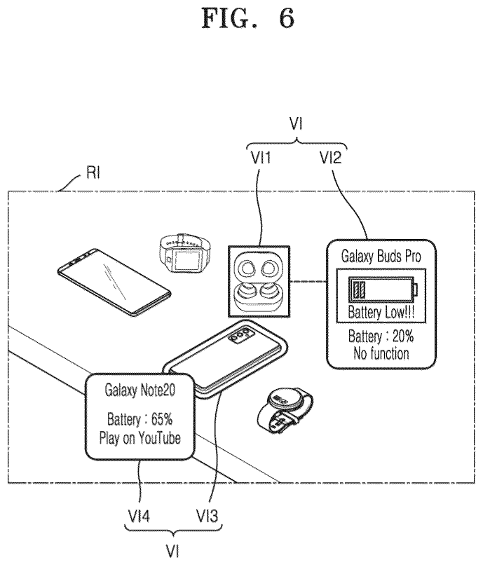

FIG. 6 is a diagram illustrating an operation in which the AR device 100 displays the AR image VI including information about a plurality of devices of interest according to an embodiment of the disclosure.

In an embodiment, the AR device 100 may display the information VI2 and VI4 of the plurality of devices of interest at a time, unlike in FIG. 5 described above. In this case, the indicator VI1 and information VI2 of a first device and the indicator VI3 and information VI4 of a second device may be displayed with colors, hatches, etc. so as to be distinguished from each other.

For example, in the embodiment of FIG. 6, the indicator VI1 and the information VI2 of the first device, which is the ‘earphones’, may be highlighted and displayed in a first color (e.g., ‘yellow’), and the indicator VI3 and the information VI4 of the second device, which is the ‘mobile phone’ may be highlighted and displayed in a second color (e.g., ‘green’). In this case, a connection line connecting the indicator VI1 to the information VI2 of the first device may also be displayed in yellow, and a connection line connecting the indicator VI3 to the information VI4 of the second device may be displayed in green.

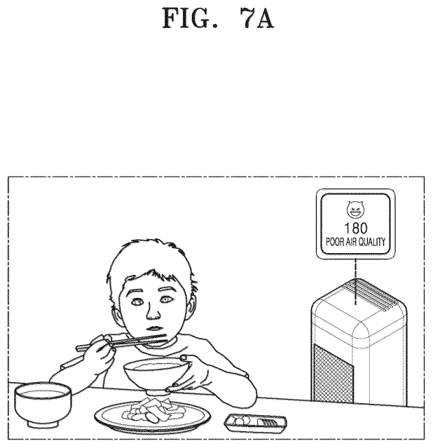

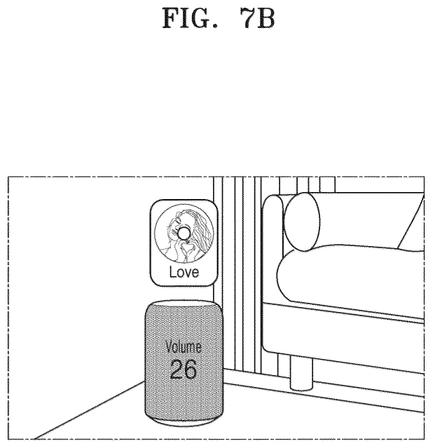

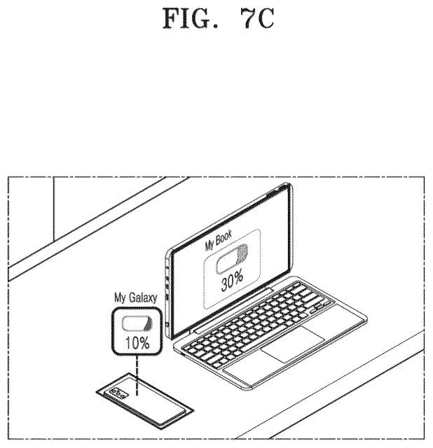

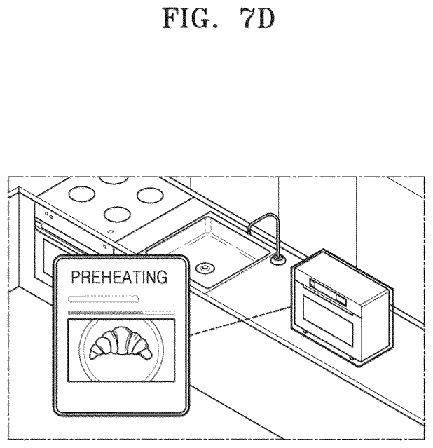

FIGS. 7A to 7D are diagrams illustrating examples in which an AR device displays an AR image including information about a device of interest, according to an embodiment of the disclosure.

Referring to FIG. 7A, when a user gazes at an air purifier that does not include its own display, the AR device may provide information related to a current state of the air purifier to the user through a virtual image. The information related to the air purifier may be displayed by being connected to an air purifier image through a connection line.

Referring to FIG. 7B, when the user gazes at a speaker that does not include its own display, the AR device may provide information related to a current state of the speaker (current volume, music information being played, etc.) to the user through a virtual image. The information related to the speaker may be displayed to overlap on a speaker image or may be displayed near the speaker image.

Referring to FIG. 7C, when the user gazes at a laptop, the AR device may determine whether to provide information related to the laptop to the user. In an embodiment, when it is determined that a facing direction of a laptop screen is a direction that makes it difficult for the user to see a screen, the AR device may provide information related to a current state of the laptop to the user through a virtual image. The information related to the laptop may be displayed to overlap with a laptop image, for example, a part corresponding to the screen of the laptop.

In FIG. 7C, an issue that requires a notification to the user (such as a low battery level) may occur in a mobile phone where the user may not see a screen of the mobile phone. In this case, even when the user gazes at another device, the AR device may provide information related to the mobile phone (such as the low battery level) to the user through a virtual image. The information related to the mobile phone may be displayed by being connected to a mobile phone image through a connection line.

Referring to FIG. 7D, the AR device may provide information related to an oven to the user, based on a selection of the user or occurrence of an issue. In FIG. 7D, a virtual image representing information about a device of interest (oven) may not be displayed near an image of the device of interest. For example, the virtual image including the information may be displayed on an area in which there is no other object in the background, or may be displayed by being enlarged in a gaze direction of the user such that the user may recognize the information well. As shown in FIG. 7D, when the virtual image including the information about the device of interest is not displayed near the image of the device of interest, the AR image may further include a connection line indicating which device of interest the virtual image corresponds to.

FIG. 8 is a block diagram of the AR device 100 according to an embodiment of the disclosure.

Referring to FIG. 8, the AR device 100 may include a communication interface 110, a camera 120, a sensor 130, a processor 140, a memory 150, and an output interface 160. The communication interface 110, the camera 120, the sensor 130, the processor 140, the memory 150, and the output interface 160 may each be electrically and/or physically connected to each other. In some embodiments, the components of the AR device 100 are not limited as shown in FIG. 8. The AR device 100 may be implemented by more components than those illustrated in FIG. 8, or the AR device 100 may be implemented by fewer components than those illustrated in FIG. 8.

In an embodiment of the disclosure, the AR device 100 may be implemented as AR glasses worn on the user's head. In this case, the AR device 100 may further include a power supply (e.g., a battery) that supplies driving power to the communication interface 110, the camera 120, the sensor 130, the processor 140, and the output interface 160. In an embodiment, the AR device 100 may not include a speaker 164.

The communication interface 110 is configured to transmit and receive data with a server or an external device (e.g., a device of interest) over a wired or wireless communication network. The communication interface 110 may perform data communication with the server or the external device by using at least one of data communication methods including, for example, wired LAN, wireless LAN, Wi-Fi, Bluetooth, Zigbee, Wi-Fi Direct (WFD), infrared communication (IrDA), Bluetooth Low Energy (BLE), Near Field Communication (NFC), Wireless Broadband Internet (Wibro), World Interoperability for Microwave Access (WiMAX), Shared Wireless Access Protocol (SWAP), Wireless Gigabit Alliance (WiGig), and RF communication. However, the communication interface 110 is not limited thereto, and when the AR device 100 is implemented as a wearable device such as smart glasses, the communication interface 110 may perform data transmission and reception with the server or the external device over a network that follows a mobile communication standard, such as CDMA, WCDMA, 3G, 4G (LTE), 5G Sub 6, and/or mmWave.

In an embodiment, the communication interface 110 may receive status information of the device of interest or information to be provided to the user as the AR image from the device of interest by the control of the processor 140. The communication interface 110 may provide the received information of the device of interest to the processor 140.

In an embodiment, the communication interface 110 may be connected to at least one device of interest through a short-distance communication method such as Bluetooth or Wi-Fi Direct, and may receive various information to be provided as a notification to the user from the device of interest.

The camera 120 is configured to acquire two-dimensional (2D) image data by photographing a real world space. The camera 120 may be implemented in a small form factor so as to be mounted on the AR device 100, and may be a lightweight RGB camera that consumes low power. However, the camera 120 is not limited thereto, and in an embodiment of the disclosure, may be implemented as any type of known camera, such as an RGB-depth camera including a depth estimation function, a dynamic vision sensor camera, a stereo fisheye camera, a grayscale camera, or an infrared camera. In an embodiment, the camera 120 may be disposed to face the user and configured to photograph the user's face.

The camera 120 may include a lens module, an image sensor, and an image processing module. The camera 120 may acquire a still image or video of a real world scene by using an image sensor (e.g., a complementary metal-oxide-semiconductor (CMOS) or a charge-coupled device (CCD)). The video may include a plurality of image frames acquired in real time by photographing a real world area through the camera 120. The image processing module may encode a still image including a single image frame or video data including a plurality of image frames acquired through an image sensor and transmit the encoded still image or video data to the processor 140.

Capturing a real world scene image according to an embodiment of the disclosure may include an operation in which the AR device 100 acquires an image by controlling the camera 120 (e.g., a camera including an image sensor and a lens) provided in the AR device 100 and converting an optical image formed through the lens into an electrical signal. For example, the one or more processors 140 may control the camera 120 provided in the AR device 100 to photograph the periphery of the AR device 100 and acquire an image (e.g., captured image) including one or more frames. Here, the image may include a live-view image.

The sensor 130 may include sensors configured to detect real world space, location, situation, or user information. In an embodiment of the disclosure, the sensor 130 may include an eye tracking sensor, an Inertial Measurement Unit (IMU) sensor, a Global Positioning System (GPS) sensor, a Bluetooth Low Energy (BLE) sensor, an Ultra Wide Broadband (UWB) sensor, or a sensor capable of sensing other various signals, but is not limited thereto.

The processor 140 may execute one or more instructions of a program stored in the memory 150. The processor 140 may include hardware components that perform arithmetic, logic, input/output operations, and image processing. In FIG. 8, one processor 140 is shown, but the processor 140 is not limited thereto and may include one or more elements. The processor 140 may correspond to one or more processors.

The processor 140 may be one processor or a plurality of processors, and may be one or more of a general-purpose processor such as a Central Processing Unit (CPU), an Application Processor (AP), and a Digital Signal Processor (DSP), a graphics dedicated processor such as a Graphics Processing Unit (GPU), and a Vision Processing Unit (VPU), or an artificial intelligence (AI) dedicated processor such as a Neural Processing Unit (NPU). The processor 140 may control input data to be processed according to a predefined operation rules or an AI model. Alternatively, when the processor 140 is the AI dedicated processor, the AI dedicated processor may be designed with a hardware structure specialized for processing a specific AI model.

The memory 150 may include at least one type storage medium of a flash memory type, a hard disk type, a multimedia card micro type, a card type memory (e.g., SD or XD memory), RAM (Random Access Memory), SRAM (Static Random Access Memory), ROM (Read Only Memory), EEPROM (Electrically Erasable Programmable Read-Only Memory), PROM (Programmable Read-Only Memory), or an optical disk. The memory 150 may correspond to one or more memory devices or storages.

The memory 150 may store instructions related to a function and/or operation for the AR device 100 to provide information about a device of interest to the user. In an embodiment, the memory 150 may store at least one of instructions, an algorithm, a data structure, a program code, or an application program that are readable by the processor 140. The instructions, the algorithm, the data structure, the program code, or the application program stored in the memory 150 may be implemented, for example, in a programming or scripting language such as C, C++, Java, assembler, etc.

The processor 140 may execute the instructions or the program code stored in the memory 150 and control overall operations of the AR device 100. The processor 140 may perform operations according to an embodiment of the disclosure. For example, the processor 140 may control all of the communication interface 110, the camera 120, the sensor 130, and the output interface 160 by executing programs stored in the memory 150.

The processor 140 may include hardware components that perform arithmetic, logic, and input/output operations and signal processing. The processor 140 may include, for example, but not limited to, at least one of a central processing unit, a microprocessor, a graphics processing unit, application specific integrated circuits (ASICs), DSPs, digital signal processing devices (DSPDs), programmable logic devices (PLDs), or field programmable gate arrays (FPGAs).

In an embodiment, the processor 140 may execute the one or more instructions stored in the memory 150 to identify the device of interest, determine whether to display information about the device of interest, display an AR image including the information about the device of interest the display through the display 162 of the output interface 160, and provide notification or the information about the device of interest to the user.

The output interface 160 is configured to output the information about the device of interest as the AR image (virtual image) or output an audio signal by the control of the processor 140. The output interface 160 may include a display 162 and a speaker 164.

The display 162 may include, for example, at least one of a liquid crystal display, a thin film transistor-liquid crystal display, an organic light-emitting diode display, a flexible display, a three-dimensional (3D) display, or an electrophoretic display.

In an embodiment, when the AR device 100 includes AR glasses, the display 162 may include a lens optical system and may include a waveguide and an optical engine. The optical engine may include a projector that generates light of an AR image including text, icons, or virtual images, and projects the light onto a waveguide. The optical engine may include, for example, an imaging panel, an illumination optical system, a projection optical system, etc. In an embodiment, the optical engine may be disposed in a frame or temples of the AR glasses.

The speaker 164 is configured to output an acoustic signal. In an embodiment, the speaker 164 may output a speech message or notification sound to assist in providing the information about the device of interest by the control of the processor 140.

FIG. 9 is a diagram illustrating an AR device 900 in the form of glasses according to an embodiment of the disclosure.

Referring to FIG. 9, the AR device 900 may display information about a device of interest through an AR image. The AR device 900 is a device capable of providing services related to AR, and may include generally AR glasses in the shape of glasses worn on the face of a user, a HMD, a VRH, or an AR helmet worn on the head. In the case of the HMD, a super-large screen may be provided to the user by placing a display in front of the user's eyes, and a realistic virtual world may be provided as the screen moves according to a user's movement.

In an embodiment, a user may wear the AR device 900, capable of displaying visual extended reality content. The AR device 900 may include an audio module capable of providing audio extended reality content to the user. In an embodiment, AR device 900 may include one or more cameras capable of capturing an image and video of an environment. The AR device 900 may include an eye tracking system to determine a vergence distance of the user. In an embodiment, the AR device 900 may include a lightweight HMD (e.g., goggles, glasses, visor, etc.) In an embodiment, the AR device 900 may include a non-HMD device, such as a lightweight and portable display device or one or more laser projection glasses (e.g., glasses capable of projecting a low-powered laser on the user's retina to project and display an image or depth content to the user).

In an embodiment, the AR device 900 may provide an AR service that outputs at least one virtual object to appear overlaid on a region determined as a user's FOV. For example, the region determined to be the user's FOV is a region determined to be perceptible by a user wearing the AR device 900 through the AR device 900, and may be a region including the entire display of the AR device 900 or at least a part of the display. In an embodiment, the AR device 900 may include a plurality of transparent members respectively corresponding to both eyes of the user.

In an embodiment, the AR device 900 may include a display module 914, a camera, an audio output unit, and support units 921 and 922.

The camera may capture an image corresponding to the user's FOV or measure a distance to an object. The camera may correspond to the camera 120 of FIG. 8. In an embodiment, the camera may be used for head tracking and spatial recognition. Also, the camera may recognize a user's movement.

In an embodiment, the camera may further include an ‘ET camera 912’, in addition to a camera 913 used for detecting an image corresponding to the user's FOV, that is, motion of an object, or spatial recognition. In an embodiment, the ET camera 912 may be used to detect and track the pupil of the user. The ET camera 912 may be used for adjusting the center of a virtual image projected on the AR device 900 to be positioned in a direction in which the eyes of the user wearing the AR device 900 gaze. For example, a global shutter (GS) camera may be used in the ET camera 912 to detect the pupil and track a fast pupil movement without a delay. The ET camera 912 may separately include a left-eye camera 912-1 and a right-eye camera 912-2.

In an embodiment, the display module 914 may include the first display 930 and the second display 920. The display module 914 may correspond to the display 162 of FIG. 8 described above. A virtual object output through the display module 914 may include information related to an application program executed on the AR device 900 or information related to an external object located in a real world space corresponding to a region determined as the user's FOV. For example, the AR device 900 may check an external object included in at least a part corresponding to the region determined as the user's FOV among image information related to the real world space acquired through the camera 913. The AR device 900 may output a virtual object related to the external object checked in the at least part through the region determined as the user's FOV among display regions of the AR device 900. The external object may include objects existing in the real world space.

In an embodiment, the first and second displays 930 and 920 each may include a condensing lens or a waveguide in a transparent member. For example, the transparent member may be formed from a glass plate, plastic plate, or polymer, and may be manufactured completely transparent or translucent. In an embodiment, the transparent member may include a first transparent member (the first display 930) facing the right eye of the user wearing the AR device 900 and a second transparent member (the second display 920) facing the left eye of the user. When the first and second displays 920 and 930 are transparent, the displays may be disposed at a position facing the user's eyes to display a screen.

The waveguide may deliver light generated from a light source of the displays to the user's eyes. For example, the waveguide may be at least partially positioned on one of the first and second displays 930 and 920. According to an embodiment, light emitted from the displays may be incident to one end of the waveguide, and the incident light may be transmitted to the user's eyes through total internal reflection within the waveguide. The waveguide may be manufactured from a transparent material such as glass, plastic, or polymer, and may include a nanopattern formed on an inner or outer surface, for example, a polygonal or curved grating structure. In an embodiment, the incident light may be propagated or reflected inside the waveguide by the nanopattern and provided to the user's eyes. In an embodiment, the waveguide includes at least one of at least one diffractive element (e.g., a diffractive optical element (DOE), a holographic optical element (HOE)) or a reflective element (e.g., a mirror). In an embodiment, the waveguide may guide a display light emitted from a light source unit to the user's eyes by using the at least one diffractive element or the reflective element.

In an embodiment, the first and second displays 930 and 920 each may include a display panel or lens (e.g., glass). For example, the display panel may include a transparent material such as glass or plastic. In an embodiment, the displays may include a transparent device, and the user may perceive a real world space behind the displays by passing through the displays. The displays may display the virtual object on at least a partial region of the transparent device so that it looks like the virtual object is added to at least a part of the real world space.

In an embodiment, the support units 921 and 922 may include respectively printed circuit boards (PCBs) 931-1 and 931-2 transmitting electrical signals to each component of the AR device 900, audio speakers 932-1 and 932-2 outputting audio signals or batteries 933-1 and 933-2 supplying power. The audio speakers 932-1 and 932-2 outputting audio signals may each correspond to the speaker 164 of FIG. 8. For example, in the glasses-type AR device 900, the support units 921 and 922 may be disposed on temple parts of the glasses. The support units 921 and 922 may respectively include hinge units 940-1 and 940-2 coupled to the main body of the AR device 900. The speakers 932-1 and 932-2 include a first speaker 932-1 transmitting an audio signal to the user's left ear and a second speaker 932-2 transmitting an audio signal to the user's right ear.

Referring to FIG. 9, the AR device 900 may include a microphone 941 receiving a user's speech and ambient sounds. In addition, the AR device 900 may include at least one illumination LED 942 to increase accuracy of at least one camera (e.g., the ET camera 912, the outward facing camera 913, or recognition cameras 911-1 and 911-2). For example, the illumination LED 942 may be used as an auxiliary means for increasing accuracy when photographing a user's pupil with the ET camera 912, and may use an IR LED of an infrared wavelength rather than a visible light wavelength. For example, the illumination LED 942 may be used as an auxiliary means when it is not easy to detect a subject due to a dark environment when photographing a user's gesture by using the recognition cameras 911-1 and 911-2.

According to an embodiment, the display module 914 may include a first light guide plate (the first display 930) corresponding to the right eye and a second light guide plate (the second display 920) corresponding to the left eye, and provide visual information to the user through the first light guide plate and the second light guide plate. According to an embodiment, the display module 914 may include a display panel and a lens (e.g., a glass lens or an LC lens). The display panel may include a transparent material such as glass or plastic.

According to an embodiment, the display module 914 may include a transparent device, and the user may pass through the display module 914 and perceive a real world space which is a rear surface of the display module 914 in front of the user. The display module 914 may display the virtual object on at least a partial region of the transparent device so that it looks like the virtual object is added to at least a part of the real world space.

In an embodiment, the AR device 900 may determine an external object included in at least a part corresponding to a region determined as the user's FOV among image information related to the real world space acquired through the outward facing camera 913. The AR device 900 may output (or display) a virtual object related to the external object checked in the at least part through a region determined as the user's FOV among display regions of the AR device 900. The external object may include objects existing in the real world space. According to various embodiments, a display region where the AR device 900 displays a virtual object may include a part of the display module 914 (e.g., at least a portion of a display panel). According to an embodiment, the display region may correspond to at least a part of each of the first light guide plate and the second light guide plate.

According to an embodiment, the AR device 900 may measure a distance to a physical object located in a front direction of the AR device 900 by using the outward facing camera 913. The outward facing camera 913 may include a high resolution camera such as a high resolution (HR) camera and a photo video (PV) camera.

The AR device 900 according to an embodiment of the disclosure is not limited to the above-described configuration, and may include various components in various positions and in various numbers.

The disclosure provides a method, performed by the AR device 100, of displaying information about another device (e.g. the device of interest 200). The method may include identifying the device of interest 200 for displaying the information. By identifying the device of interest 200 for displaying the information among other devices, the AR device 100 does not provide notifications of all external devices to the user U, but may select only a device requiring a notification and provide the notification to the user U. Accordingly, excessive information may be prevented from being provided to the user U, and a data overhead may be reduced. The method may include determining whether to display the information about the device of interest 200. The AR device 100 directly determine whether to display the information about the device of interest 200, and thus, only when a specific notification is not provided to the user U through any route, the AR device 100 may provide the notification. When the specific notification is displayed through a display screen embedded in the corresponding device or provided to the user U through other means, the AR device 100 may not repeatedly provide the same information to the user U. Accordingly, excessive information may be prevented from being provided to the user U, and a data overhead may be reduced. The method may include displaying an AR image including the information about the device of interest 200. The AR device 100 may display the specific notification near the device of interest 200 or overlay the notification on the device of interest 200, thereby providing necessary notifications to the user U in a timely manner.

In an embodiment, the determining of whether to display the information about the device of interest 200 may include receiving device identification information and notification information from the device of interest 200, identifying whether the device of interest 200 includes a display screen based on the device identification information, and when the device of interest 200 does not include the display screen, determining to display the notification information.

In an embodiment, the determining of whether to display the information about the device of interest 200 may include determining whether to display the information about the device of interest 200 based on a facing direction of the display screen when the device of interest 200 includes the display screen.

In an embodiment, the determining of whether to display the information about the device of interest 200 based on the facing direction of the display screen may include determining to display the information about the device of interest 200 when a difference between the facing direction of the display screen and a direction of the AR device 100 from the device of interest 200 is greater than a preset threshold angle.

In an embodiment, the determining of whether to display the information about the device of interest 200 may include measuring a distance between the AR device 100 and the device of interest 200 when the device of interest 200 includes the display screen, and determining whether to display the information about the device of interest 200 based on the distance between the AR device 100 and the device of interest 200.

In an embodiment, the determining of whether to display the information about the device of interest 200 based on the distance between the AR device 100 and the device of interest 200 may include determining to display the information about the device of interest 200 when the distance between the AR device 100 and the device of interest 200 is greater than a preset threshold value.

In an embodiment, the device of interest 200 may include at least one of a device in which an event occurred among devices connected to the AR device 100, a device selected by a user from among the devices connected to the AR device 100, or a device newly connected to the AR device 100.

In an embodiment, the identifying of the device of interest 200 may include identifying a device at which a user is gazing through an eye tracking sensor, identifying whether the device at which the user is gazing is connected to the AR device 100, and when the device at which the user is gazing is connected to the AR device 100, determining the device at which the user is gazing as the device of interest 200.

In an embodiment, the identifying of the device at which the user is gazing through the eye tracking sensor may include acquiring a gaze direction of the user through the eye tracking sensor, acquiring a real world scene image through the camera 120, identifying at least one device from the real world scene image, and determining the device at which the user is gazing based on a location of the at least one device in the real world scene image and the gaze direction of the user.

In an embodiment, the displaying of the AR image comprising the information about the device of interest 200 may include acquiring a real world scene image through the camera 120, identifying the device of interest 200 from the real world scene image, based on a location of the device of interest 200, determining an area to display the AR image, and displaying the AR image on the determined area.

The disclosure provides an AR device displaying information about a device connected thereto. The AR device may include a camera 120 configured to acquire a real world scene image. The AR device may include a display. The AR device may include a memory storing a program comprising one or more instructions. The AR device may include at least one processor. The at least one processor may identify a device of interest, determine whether to display information about the device of interest, and display an AR image comprising the information about the device of interest through the display.

In an embodiment, the at least one processor may receive device identification information and notification information from the device of interest. The at least one processor may identify whether the device of interest includes a display screen based on the device identification information. The at least one processor may determine to display the notification information when the device of interest does not include the display screen.

In an embodiment, the at least one processor may determine whether to display the information about the device of interest based on a facing direction of the display screen when the device of interest includes the display screen.

In an embodiment, the at least one processor may determine to display the information about the device of interest when a difference between the facing direction of the display screen and a direction of the AR device from the device of interest is greater than a preset threshold angle.

In an embodiment, the at least one processor may measure a distance between the AR device and the device of interest when the device of interest includes the display screen. The at least one processor may determine whether to display the information about the device of interest based on the distance between the AR device and the device of interest.

In an embodiment, the at least one processor may determine to display the information about the device of interest when the distance between the AR device and the device of interest is greater than a preset threshold value.

In an embodiment, the at least one processor may identify a device at which a user is gazing through an eye tracking sensor. The at least one processor may identify whether the device at which the user is gazing is connected to the AR device. The at least one processor may determine the device at which the user is gazing as the device of interest when the device at which the user is gazing is connected to the AR device.

In an embodiment, the at least one processor may acquire a gaze direction of the user through the eye tracking sensor. The at least one processor may acquire a real world scene image through the camera. The at least one processor may identify at least one device from the real world scene image. The at least one processor may determine the device at which the user is gazing based on a location of the at least one device in the real world scene image and the gaze direction of the user.

In an embodiment, the at least one processor may acquire a real world scene image through the camera. The at least one processor may identify the device of interest from the real world scene image. The at least one processor may determine an area to display the AR image based on a location of the device of interest. The at least one processor may display the AR image on the determined area.

The disclosure provides a computer program product including a computer-readable storage medium. The storage medium may store instructions for executing at least one of the embodiments of the method on an AR device and readable by the AR device.

As described above, according to an embodiment of the disclosure, when an important situation occurs in the device of interest without the user being aware of the information about the device of interest, or when the user wants to know the information about the device, the information may be effectively provided. In addition, the notification may be provided by selecting only a device that requires the notification to the user, thereby preventing excessive information from being provided to the user and reducing a data overhead.

An embodiment of the disclosure may be implemented or supported by one or more computer programs, and the computer programs may be formed from computer-readable program code and may be included in a computer-readable medium. In the disclosure, the terms “application” and “program” may refer to one or more computer programs, software components, instruction sets, procedures, functions, objects, classes, instances, related data, or a portion thereof suitable for implementation in computer-readable program code. The “computer-readable program code” may include various types of computer code including source code, object code, and executable code. The “computer-readable medium” may include various types of mediums accessed by a computer, such as read only memories (ROMs), random access memories (RAMs), hard disk drives (HDDs), compact disks (CDs), digital video disks (DVDs), or various types of memories.

Also, a machine-readable storage medium may be provided in the form of a non-transitory storage medium. Here, the ‘non-transitory storage medium’ may be a tangible device and may exclude wired, wireless, optical, or other communication links for transmitting temporary electrical or other signals. Moreover, the ‘non-transitory storage medium’ may not distinguish between a case where data is semi-permanently stored in the storage medium and a case where data is temporarily stored therein. For example, the “non-transitory storage medium” may include a buffer in which data is temporarily stored. The computer-readable medium may be any available medium accessible by a computer and may include volatile or non-volatile mediums and removable or non-removable mediums. The computer-readable medium may include a medium in which data may be permanently stored and a medium in which data may be stored and may be overwritten later, such as a rewritable optical disk or an erasable memory device.

Embodiments of the disclosure may be implemented with a software program including instructions stored in a computer-readable storage medium. The computer is a device capable of calling out instructions stored in a storage medium and operating under the instructions as in the embodiments of the disclosure, and may include an electronic device according to the embodiments of the disclosure.

The method according to embodiments of the disclosure may be included and provided in a computer program product. The computer program product may include a software program and a computer-readable storage medium having the software program stored thereon. For example, the computer program product may include a product (e.g., a downloadable app) in the form of a software program that is electronically distributed by the manufacturer of the device or by an electronic market. For the electronic distribution, at least a portion of the software program may be stored in a storage medium or arbitrarily created. In this case, the storage medium may be one of a server of the manufacturer or of a relay server that temporarily stores the software program.

In a system including a server and a device, the computer program product may include a storage medium of the server or a storage medium of the device. Alternatively, when there is a third device (e.g., a smart phone) communicatively connected to the server or the device, the computer program product may include a storage medium of the third device. In another example, the computer program product may be transferred from the server to the device or the third party, or may include a software program itself that is transferred from the third device to the device.

In this case, one of the server, the device, and the third device may execute the computer program product to perform the method according to the embodiments of the disclosure. Alternatively, two or more of the server, the device, and the third device may execute the computer program product to perform the method according to the embodiments of the disclosure in a distributed fashion.

For example, the server (e.g., a cloud server or an AI server) may execute the computer program product stored therein to control the device communicatively connected to the server to perform the method according to the embodiments of the disclosure.

In yet another example, the third device may execute the computer program product to control the device communicatively connected to the third device to perform the method according to the embodiments of the disclosure. In the case that the third device executes the computer program product, the third device may download the computer program product and execute the downloaded computer program product. Alternatively, the third device may execute the computer program product that is preloaded to perform the method according to the embodiments of the disclosure.

The foregoing is illustrative of embodiments of the disclosure, and those of ordinary skill in the art will readily understand that various modifications may be made therein without materially departing from the spirit or features of the disclosure. Therefore, it is to be understood that the embodiments described above should be considered in a descriptive sense only and not for purposes of limitation. For example, each component described as a single type may also be implemented in a distributed manner, and likewise, components described as being distributed may also be implemented in a combined form.

The scope of the disclosure is defined not by the above detailed description but by the following claims, and all modifications derived from the meaning and scope of the claims and equivalent concepts thereof should be construed as being included in the scope of the disclosure.

What is claimed is:

1. A method, performed by an augmented reality (AR) device, the method comprising:
identifying a device of interest;
determining whether to display information about the device of interest; and
displaying an AR image corresponding to the information about the device of interest.

2. The method of claim 1, wherein the determining whether to display the information about the device of interest comprises:
receiving device identification information and notification information from the device of interest;
identifying whether the device of interest includes a display screen based on the device identification information; and
based on identifying that the device of interest does not include the display screen, determining to display the notification information.

3. The method of claim 2, wherein the determining whether to display the information about the device of interest comprises, based on identifying that the device of interest includes the display screen, determining whether to display the information about the device of interest based on a facing direction of the display screen.

4. The method of claim 3, wherein the determining whether to display the information about the device of interest based on the facing direction of the display screen comprises, based on a difference between the facing direction of the display screen and a direction of the AR device from the device of interest being greater than a preset threshold angle, determining to display the information about the device of interest.

5. The method of claim 2, wherein the determining whether to display the information about the device of interest comprises:
based on identifying that the device of interest includes the display screen, measuring a distance between the AR device and the device of interest; and
determining whether to display the information about the device of interest based on the distance between the AR device and the device of interest.

6. The method of claim 5, wherein the determining whether to display the information about the device of interest based on the distance between the AR device and the device of interest comprises, based on the distance between the AR device and the device of interest being greater than a preset threshold value, determining to display the information about the device of interest.

7. The method of claim 1, wherein the device of interest comprises at least one of:
a device in which an event occurred among devices connected to the AR device,
a device selected by a user from among the devices connected to the AR device, or
a device newly connected to the AR device.

8. The method of claim 1, wherein the identifying the device of interest comprises:
identifying, through an eye tracking sensor, a device at which a user is gazing;
identifying whether the device at which the user is gazing is connected to the AR device; and
based on identifying that the device at which the user is gazing is connected to the AR device, determining the device at which the user is gazing as the device of interest.

9. The method of claim 8, wherein the identifying, through the eye tracking sensor, the device at which the user is gazing comprises:
acquiring, through the eye tracking sensor, a gaze direction of the user;
acquiring, through a camera, a real world scene image;
identifying at least one device from the real world scene image; and
determining the device at which the user is gazing based on a location of the at least one device in the real world scene image and the gaze direction of the user.

10. The method of claim 1, wherein the displaying the AR image corresponding to the information about the device of interest comprises:
acquiring, through a camera, a real world scene image;
identifying the device of interest from the real world scene image;
determining an area to display the AR image based on a location of the device of interest; and
displaying the AR image on the determined area.

11. An augmented reality (AR) device configured to display information about a device connected to the AR device, the AR device comprising:
a display;
a memory storing a program comprising one or more instructions; and
at least one processor configured to execute the one or more instructions,
wherein the one or more instructions, when executed by the at least one processor, cause the AR device to:
identify a device of interest,
determine whether to display information about the device of interest, and
display an AR image corresponding to the information about the device of interest through the display.

12. The AR device of claim 11, wherein the one or more instructions, when executed by the at least one processor, further cause the AR device to:
receive device identification information and notification information from the device of interest,
identify whether the device of interest includes a display screen based on the device identification information, and
based on identifying that the device of interest does not include the display screen, determine to display the notification information.

13. The AR device of claim 12, wherein the one or more instructions, when executed by the at least one processor, further cause the AR device to, based on identifying that the device of interest includes the display screen, determine whether to display the information about the device of interest based on a facing direction of the display screen.

14. The AR device of claim 12, wherein the one or more instructions, when executed by the at least one processor, further cause the AR device to:
based on identifying that the device of interest includes the display screen, measure a distance between the AR device and the device of interest, and
determine whether to display the information about the device of interest based on the distance between the AR device and the device of interest.

15. The AR device of claim 11, wherein the one or more instructions, when executed by the at least one processor, further cause the AR device to:
identify, through an eye tracking sensor, a device at which a user is gazing,
identify whether the device at which the user is gazing is connected to the AR device, and
based on identifying that the device at which the user is gazing is connected to the AR device, determine the device at which the user is gazing as the device of interest.
